(19) United States
(12) Patent Application Publication
(10) Pub. No.: US 2011/0292292 A1
(43) Pub. Date: Dec. 1, 2011

(54) METHOD AND APPARATUS FOR DISPLAYING VIDEO DATA

(75) Inventors: Ashish GOEL, Noida (IN); Kshitij Bajaj, Ghaziabad (IN); Vandana Bansal, Noida (IN); Ankit Gupta, Ghaziabad (IN); Gurinder Singh, Haryana (IN)

(73) Assignee: FREESCALE SEMICONDUCTOR, INC, Austin, TX (US)

(21) Appl. No.: 12/786,460

(22) Filed: May 25, 2010

(51) Int. Cl. H04N 5/268

(52) U.S. Cl. 348/705; 348/E05.057

(57) ABSTRACT

A method of displaying consecutively first and second asynchronous video data streams on a display device, where there is a transition from the first video data stream to the second video data stream. The transition includes interrupting updating the display on the video display device during a prolonged vertical blanking interval in response to assertion of a vertical blanking pulse in the first video stream until subsequent de-assertion of a vertical blanking pulse in the second video stream, and displaying the second video data stream starting with a frame following the subsequent de-assertion of the vertical blanking pulse in the second video stream.

### BACKGROUND OF THE INVENTION

The present invention is directed to a method and apparatus for displaying video data and, more particularly, to switching from displaying a first video signal to a second video signal, where the first and second video signals are not synchronized.

Displays of video data commonly make use of vertical and horizontal synchronization. Vertical synchronization refers generally to the synchronization of frame changes with a vertical blanking interval. For example, frame buffers in computer graphics hardware and other common video display devices are generally designed to draw images from the top down a line at a time, replacing the data of the previous frame in a frame buffer with that of the next frame in a similar fashion. If the frame buffer is updated with a new image while the image is being transmitted to the display, the display includes parts of both frames, producing a page tearing artifact partway down the image. Normally, vertical synchronization eliminates this by timing frame buffer fills to coincide with the vertical blanking interval, thus ensuring that only whole frames are seen by the viewer. During the blanking intervals, the display usually remains activated and is not literally blanked out, but the display is not updated until after the end of the blanking interval.

When switching between two different video data streams from different, sources, the two video data streams may be asynchronous. This may be the case if the video streams are from separate sources, especially if one or both of the video streams contains live data. In this case the blanking intervals of the two streams, including the vertical blanking intervals, may be out of phase and, if no precautions are taken, the transition from one video image to the other is visible to the viewer, for example as page tearing, or missing or blank frames.

Switching between two asynchronous video data streams may occur in transport applications such as automotive, aviation or railway, for example. Dynamic switching may occur in such applications between computer generated pre-processed and stored static graphics (such as maps, displays, icons, stored video, games) or text and real-time dynamic graphic or text data (such as camera input, live TV transmission, for example). In such a scenario, it is desirable to avoid the viewer seeing any flickering on the screen, such as loss of a whole frame or insertion of a blank frame during transition.

US Patent Application No. 2007/0182835 describes a video information and display system in which, while current video data is processed and displayed, image video information scheduled to be displayed next is stored, so that switching to the stored image can be performed seamlessly. Using such a system to synchronize the displays from asynchronous sources requires a large memory just to store frames of the video data to be displayed next. For example a frame of video data in the Video Graphics Array ('VGA') format contains 3 Bytes (1 pixel of color data in RGB)*640*480>900 KB of data.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a schematic block diagram of a video display apparatus in accordance with one embodiment of the invention;

FIG. 2 is a simplified flow chart of a known method of displaying consecutively video data from first and second asynchronous video data streams;

FIG. 3 is a simplified flow chart of a method of displaying consecutively video data from first and second asynchronous video data streams in accordance with one embodiment of the invention; and

FIG. 4 is a simplified timing chart of blanking pulses appearing in the method of FIG. 3.

### DETAILED DESCRIPTION OF PREFERRED EMBODIMENTS

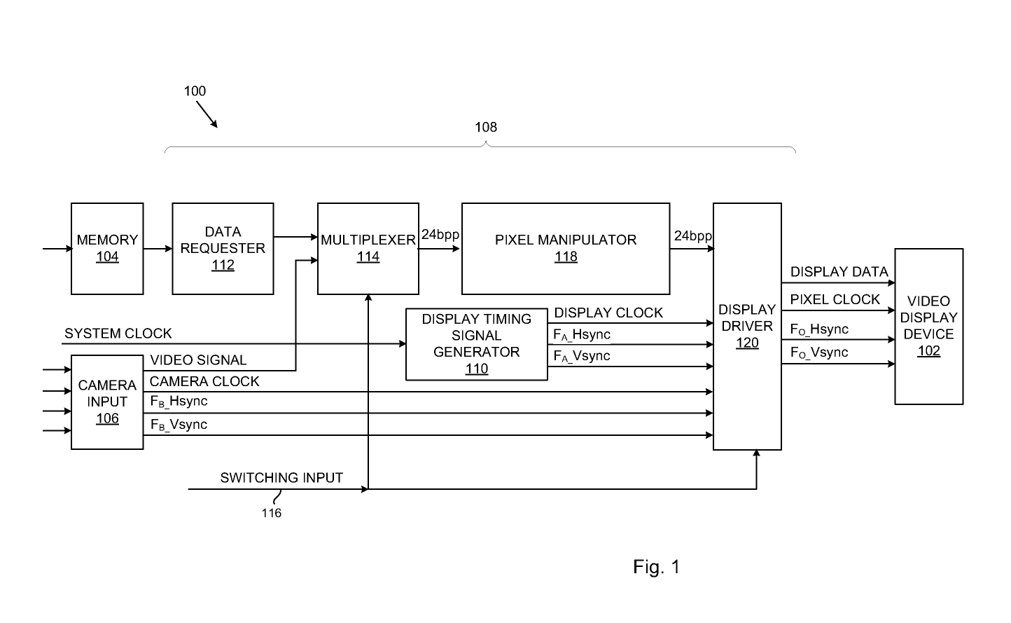

FIG. 1 shows a video display apparatus 100 for displaying consecutively video data from a first video data stream and from a second video data stream, in accordance with one embodiment of the present invention. The apparatus 100 includes a video display device 102, sources 104 and 106 of first and second video data streams respectively and a display controller 108. The first and second video data streams comprise respectively frames separated by vertical blanking pulses and are asynchronous relative to each other. In particular their blanking pulses may be out of phase. In this example, the source 104 of the first video data stream is a memory device that stores pre-processed video data at pixel level and the source 106 of the second video data stream is a live video data source, such as a camera.

For example, in an automotive display, the memory 104 may receive graphics and text information to be transmitted to a driver from a central processing unit (‘CPU’, not shown), such as speed, distance, fuel consumption, warning messages and so on, and the live data source 106 may be a camera that records rear view scenes, for example when the vehicle is reversing. The display device 102 may be a dashboard mounted display device or a video projector for projecting images onto the windshield, for example.

In another example of an application to public transport displays, the memory 104 may receive information to be displayed to passengers, such as destination, current position relative to stations and timing, and the data source 106 may be a source of recorded or live images or films to be displayed to the passengers.

The display controller 108 includes a display timing signal generator 110 that generates display blanking pulses, especially horizontal and vertical blanking pulses for the pixel data from the memory 104. The display controller 108 also includes a data requester 112 for fetching pixel data from desired addresses in the memory 104 at a rate suitable for the video output to the display device 102. It will be appreciated that the memory 104, the display timing signal generator 110 and the data requester 112 could be replaced by other pre-processed or real-time video display pixel generators.

The display controller 108 also includes a multiplexer 114. The multiplexer 114 receives video signals including streams of pixel data from the first video data source 104 by way of the data requester 112 and from the second video data source 106, and selects one of the data streams as a function of a switching input signal 116, from the CPU for example. The pixel stream from the multiplexer 114 is then passed to a pixel manipulator 118. The pixel manipulator 118 modifies the pixel data to a desired format suitable for the display device 102. The pixel manipulator 118 can include format conversion, blending, chroma keying, gamma correction, tiling, and cursor generation, for example. It will be appreciated that the pixel manipulator 118 may include a buffer to store pixel data but does not need to store the entire display signal data. A display driver 120 in the display controller 108 receives clock signals, horizontal blanking pulses F_{A}_{_{—}}Hsync and F_{B}_{_{—}}Hsync and vertical blanking pulses F_{A}_{_{—}}Vsync and F_{B}_{_{—}}Vsync from the display timing signal generator 110 and from the second video data source 106 respectively and generates an output clock signal (i.e., pixel clock), horizontal blanking pulses F₀_{_{—}}Hsync and vertical blanking pulses F₀_{_{—}}Vsync for the video display device 102.

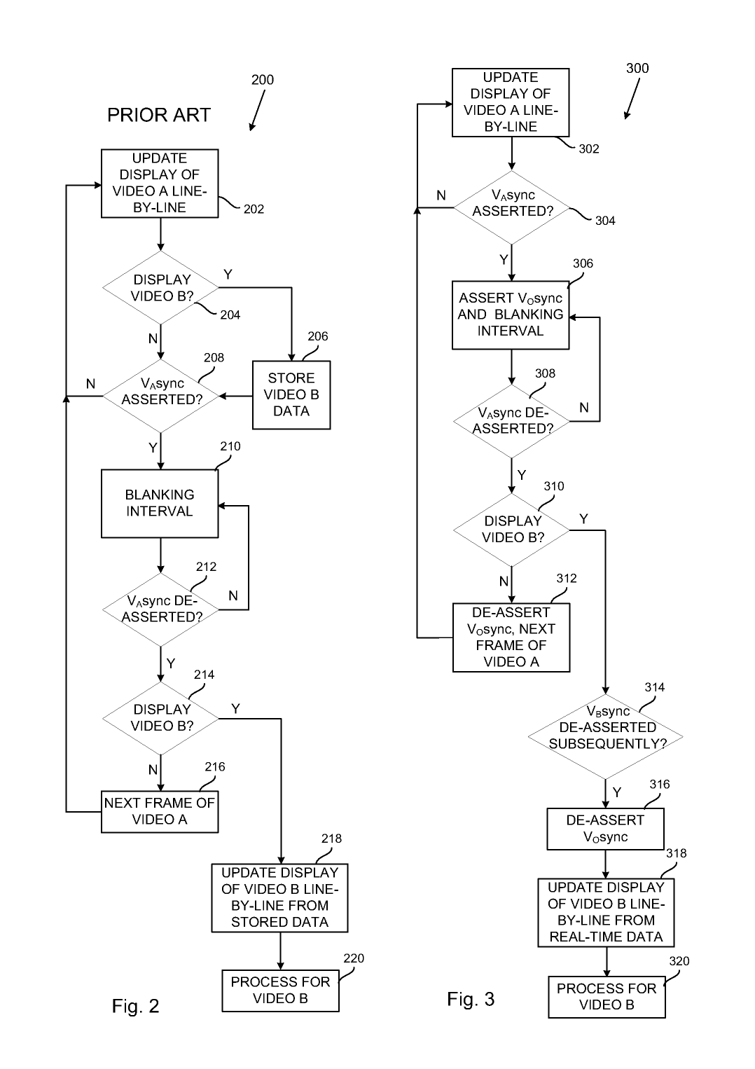

FIG. 2 shows a known method 200 of displaying consecutively video data from first and second asynchronous video data streams, such as from the first and second sources of asynchronous video data 104 and 106. The method starts with the display of video A data updated at 202 line-by-line on a display device such as 102. At 204, if a switching signal F_{B}_{_{—}}Select, such as the switching input signal 116, is asserted to trigger display of video B data, the video B data is stored continuously in a buffer at 206 to delay the pixel stream and blanking pulses of video B and the process proceeds to a step 208. If at step 204 the switching signal F_{B}_{_{—}}Select is not asserted to select display of video B data, the process proceeds directly to step 208. At 208, if the vertical blanking pulse F_{A}_{_{—}}Vsync of video A is not asserted, the process returns to 202 and continues updating the display of video A line-by-line.

If the vertical blanking pulse F_{A}_{_{—}}Vsync of video A is asserted at 208, the process proceeds to a blanking interval at 210, in which updating the display on the video display device is interrupted. At 212, if the vertical blanking pulse F_{A}_{_{—}}Vsync of video A is still asserted, the process continues the blanking interval 210. When the vertical blanking pulse F_{A}_{_{—}}Vsync of video A is de-asserted at 212, if at 214 the switching signal F_{B}_{_{—}}Select is not asserted to select display of video B data, the process proceeds to the next frame of video A at step 216 and reverts to updating the display of video A data at 202 line-by-line. If at 214 the switching signal F_{B}_{_{—}}Select is asserted to select display of video B data, the process proceeds at 218 to display the video B data stored in the buffer at step 206, updating the display of video B data at 202 line-by-line. The process 200 then continues at 220 in analogous fashion for video B.

The known method 200 of displaying consecutively video data from two asynchronous video data streams requires a large memory just to store frames of the video data stream to be displayed next. For example, a frame of video data in Video Graphics Array (‘VGA’) format contains 3 bytes (1 pixel of color data in RGB)*640*480>900 KB of data.

FIG. 3 shows a method 300 of displaying consecutively video data from first and second asynchronous video data streams, such as from the first and second sources of asynchronous video data 104 and 106, in accordance one embodiment of the present invention, which avoids the need for a buffer to store video B data. Again, the first and second video data streams comprise respectively frames separated by vertical blanking pulses. In the example shown in FIG. 3, the method starts with the display of video A data being updated at 302 line-by-line on a display device such as the display device 102. At 304, if the vertical blanking pulse F_{A}_{_{—}}Vsync of video A is not asserted, the process reverts to 302 and continues updating the display of video A line-by-line. When the vertical blanking pulse F_{A}_{_{—}}Vsync of video A is asserted at 304, the display driver 120 generates an output vertical blanking pulse F₀_{_{—}}Vsync and starts a blanking interval, in which updating the display on the video display device 102 is interrupted. The video display device 102 displays video data from the first video data stream and the display is updated until assertion of the output vertical blanking pulse F₀_{_{—}}Vsync, when the vertical blanking pulse F_{A}_{_{—}}Vsync of video A is asserted, terminates a frame in the first video stream.

At 308, if the vertical blanking pulse F_{A}_{_{—}}Vsync of video A is still asserted, the process continues to assert the output vertical blanking pulse F₀_{_{—}}Vsync and maintains the blanking interval at 306. When the vertical blanking pulse F_{A}_{_{—}}Vsync of video A is de-asserted at 308, if the switching signal F_{B}_{_{—}}Select, such as the switching input signal 116, is not asserted at 310 to select display of video B data, the process proceeds to the next frame of video A at step 312 and reverts to updating the display of video A data at 302 line-by-line.

If at 310 the switching signal F_{B}_{_{—}}Select is asserted to select display of video B data, the process starts a transition from the first video data stream to the second video data stream at step 314. At 314, if the vertical blanking pulse F_{B}_{_{—}}Vsync of video B has not been asserted since the last assertion of the vertical blanking pulse F_{A}_{_{—}}Vsync of video A, or if it has been asserted since the last assertion of the vertical blanking pulse F_{A}_{_{—}}Vsync but it has not yet been de-asserted, the process continues to assert the output vertical blanking pulse F₀_{_{—}}Vsync, which is thus prolonged, to interrupt updating the display on the display device during a prolonged blanking interval. When at 314 the vertical blanking pulse F_{B}_{_{—}}Vsync of video B has been asserted since the last assertion of the vertical blanking pulse F_{A}_{_{—}}Vsync of video A and is subsequently de-asserted, the display driver 120 de-asserts the output vertical blanking pulse F₀_{_{—}}Vsync at 316. The process terminates the prolonged blanking interval and at 318 proceeds to display video B data from the second source 106 in real-time, that is to say without additional buffering to synchronize the displays, updating the display of video A data at 202 line-by-line. The process 300 then continues at 320 in analogous fashion for video B. Since the output vertical blanking pulse F₀_{_{—}}Vsync is now synchronized with the vertical blanking pulse F_{B}_{_{—}}Vsync of video B, the output horizontal blanking pulses F₀_{_{—}}Hsync are also synchronized with the horizontal blanking pulses F_{B}_{_{—}}Hsync of video B and no extra buffering is needed to bring the streams into synchronization.

Video data from the second video data stream B is displayed on the video display device 102 starting from a first occurrence of de-assertion of the vertical blanking pulse F_{B}_{_{—}}Vsync and start of a new frame in the second video stream B following the assertion of the vertical blanking pulse F_{A}_{_{—}}Vsync in the first video stream A. Updating the display on the video display device 102 is interrupted during the transition for a duration less than a duration of one frame of the first or second video data stream A or B.

When the second video data stream B contains live data, for example from a camera, the video data stream B cannot normally be synchronized with the first video data stream A from a different source without additional buffering. However, the method of FIG. 3 enables the transition from displaying the first video data stream A to displaying the second, asynchronous video data stream B to be handled without tearing of the image or blank frames. The method of FIG. 3 is applicable even if the second video data stream B contains live data while the first video data stream contains pre-processed data stored in a memory.

In this embodiment of the present invention, the memory 104 stores video data for a first video signal, the first video signal including frames of data separated by vertical blanking pulses. The multiplexer 114 has a first input connected to the memory 104 for receiving the first video signal, a second input for receiving the second video signal, and a control input that receives the switch control signal 116 for selecting between outputting of the first and second video signals. The display driver 120 is connected to the multiplexer 114 for receiving and outputting the selected one of the first and second video signals. The timing generator 110 prolongs a vertical blanking pulse of the first video signal: upon receipt of the signal switch control signal, the timing generator 110 prolongs the next vertical blanking pulse of the first video signal and upon receipt of a new frame of the second video signal, de-asserts the prolonged vertical blanking pulse.

In the display controller 108, the combined video signals from the display driver 120 applied to the video display device 102 include consecutively video data from the first and second video data streams A and B. The first and second video data streams A and B comprise respectively frames separated by vertical blanking pulses F_{A}_{_{—}}Vsync and F_{B}_{_{—}}Vsync and are asynchronous relative to each other. At steps 306 to 310, assertion of the vertical blanking pulse F₀_{_{—}}Vsync in the combined video signals and assertion of the switching signal F_{B}_{_{—}}Select, starts a transition from the first video data stream A to the second video data stream B. The display controller 108 is operative during the transition to include in the combined video signal from the video display driver 120 video data from the first video data stream A which is updated until assertion of a vertical blanking pulse F_{A}_{_{—}}Vsync in the first video stream A terminates a frame of data in the first video stream A. During the transition, the vertical blanking pulse F₀_{_{—}}Vsync is asserted in response to assertion of the vertical blanking pulse F_{A}_{_{—}}Vsync in the first video stream A to interrupt updating the display on the video display device 102 and is prolonged until it is de-asserted in response to de-assertion of a subsequent vertical blanking pulse F_{B}_{_{—}}Vsync in the second video stream B. The combined video signals from the display driver 120 continue with video data from the second video data stream B beginning with the start of a new frame following de-assertion of the prolonged vertical blanking pulses F_{B}_{_{—}}Vsync and F₀_{_{—}}Vsync.

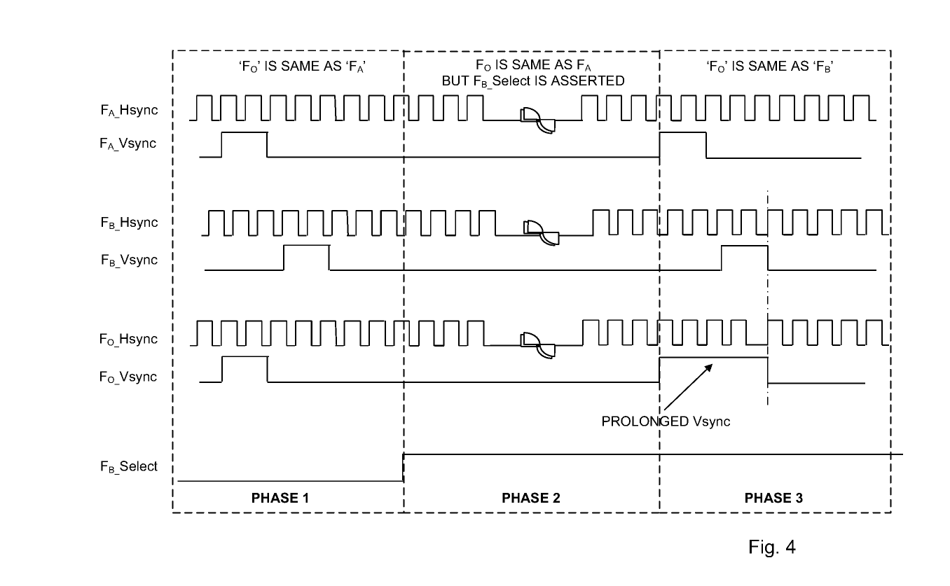

FIG. 4 is a timing diagram that shows in more detail the signals used in operation of the video display apparatus 100 according to the method shown in FIG. 3 as a function of time. The horizontal and vertical blanking pulses F_{A}_{_{—}}Hsync and F_{A}_{_{—}}Vsync are the blanking pulses of the first video data stream A from the source 104. The horizontal and vertical blanking pulses F_{B}_{_{—}}Hsync and F_{B}_{_{—}}Vsync are the blanking pulses of the second video data stream B from the source 106. The horizontal and vertical blanking pulses F₀_{_{—}}Hsync and F₀_{_{—}}Vsync are the blanking pulses of the combined video data stream from the display driver 120. The signal F_{B}_{_{—}}Select is the switching signal applied to the line 116. Since the first and second video data streams are asynchronous, the horizontal and vertical blanking pulses F_{A}_{_{—}}Hsync and F_{A}_{_{—}}Vsync of the first video data stream A are out of phase with the horizontal and vertical blanking pulses F_{B}_{_{—}}Hsync and F_{B}_{_{—}}Vsync of the second video data stream B.

During a period Phase 1, corresponding to steps 302 to 312 of FIG. 3, the signal F_{B}_{_{—}}Select is de-asserted so as to select the first video data stream A for display. The horizontal and vertical blanking pulses F₀_{_{—}}Hsync and F₀_{_{—}}Vsync are in phase with the horizontal and vertical blanking pulses F_{A}_{_{—}}Hsync and F_{A}_{_{—}}Vsync of the first video data stream A and the video display device 102 receives signals corresponding to the first video data stream A to display.

During a period Phase 2 the transition to displaying the second video data stream B starts. The signal F_{B}_{_{—}}Select is asserted, that is to say it commands selection of the second video data stream B for display. However, until the vertical blanking pulse F_{A}_{_{—}}Vsync of the first video data stream A is asserted, corresponding to step 304 of FIG. 3, the horizontal and vertical blanking pulses F₀_{_{—}}Hsync and F₀_{_{—}}Vsync remain in phase with the horizontal and vertical blanking pulses F_{A}_{_{—}}Hsync and F_{A}_{_{—}}Vsync of the first video data stream A and the video display device 102 receives from the video display driver 120 signals corresponding to the first video data stream A to display.

During a period Phase 3 the signal F_{B}_{_{—}}Select remains asserted to command selection of the second video data stream B for display. When the vertical blanking pulse F_{A}_{_{—}}Vsync of the first video data stream A is asserted, corresponding to step 304 of FIG. 3, the vertical blanking pulse F₀_{_{—}}Vsync is asserted, starting the blanking interval of the video display device 102 and terminating update of the frame of the first video data stream A, corresponding to step 306 of FIG. 3. Even when the vertical blanking pulse F_{A}_{_{—}}Vsync of the first video data stream A is de-asserted, corresponding to step 308 of FIG. 3, the vertical blanking pulse F₀_{_{—}}Vsync is not de-asserted until the vertical blanking pulse F_{B}_{_{—}}Vsync of the second video data stream B is subsequently de-asserted corresponding to steps 314 and 316 of FIG. 3. The horizontal and vertical blanking pulses F₀_{_{—}}Hsync and F₀_{_{—}}Vsync are thereafter in phase with the horizontal and vertical blanking pulses F_{B}_{_{—}}Hsync and F_{B}_{_{—}}Vsync of the second video data stream B and the video display device 102 receives signals corresponding to the second video data stream B to display corresponding to step 318 of FIG. 3.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

As used herein, the terms “assert” or “set” and “negate” (or “de-assert” or “clear”) are used herein when referring to the rendering of a signal, status bit, or similar apparatus into its logically true or logically false state, respectively. If the logically true state is a logic level one, the logically false state is a logic level zero and if the logically true state is a logic level zero, the logically false state is a logic level one.

Where the apparatus implementing the present invention is composed of electronic components and circuits known to those skilled in the art, circuit details have not been explained to any greater extent than that considered necessary for the understanding and appreciation of the underlying concepts of the present invention.

Further, it will be appreciated that boundaries described and shown between the functionality of circuit elements and/or operations in an embodiment of the invention are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

In the claims, any reference signs placed between parentheses shall not be construed as limiting the claim. Where the context admits, terms such as “first” and “second” are used to distinguish arbitrarily between the elements such terms describe and these terms are not necessarily intended to indicate temporal or other prioritization of such elements.

1. A method of displaying video data from first and second video data streams on a video display device, said first and second video data streams comprising respectively frames separated by vertical blanking pulses, wherein said first and second video data streams are asynchronous, the method including a transition from said first video data stream to said second video data stream, said transition comprising:
displaying on said video display device video data from said first video data stream that is updated until assertion of a vertical blanking pulse terminates a frame in said first video stream;
interrupting updating said display on said video display device during a prolonged vertical blanking interval in response to assertion of said vertical blanking pulse in said first video stream until subsequent de-assertion of a vertical blanking pulse in said second video stream; and
displaying on said video display device video data from said second video data stream starting with a frame following said subsequent de-assertion of said vertical blanking pulse in said second video stream.

2. The method of displaying video data of claim 0, wherein said first and second video data streams are displayed consecutively

3. The method of displaying video data of claim 0, further comprising:
generating a switching signal for triggering said transition from said first video data stream to said second video data stream, and
updating said display on said video display device being interrupted in response to a first occurrence of assertion of said vertical blanking pulse in said first video stream following said switching signal.

4. The method of displaying video data of claim 0, wherein video data from said second video data stream is displayed on said video display device starting from a first occurrence of de-assertion of said vertical blanking pulse in said second video stream following said assertion of said vertical blanking pulse in said first video stream, wherein updating said display on said video display device is interrupted during said transition for a duration less than a duration of one frame of said first or second video data stream.

5. The method of displaying video data of claim 0, wherein said second video data stream contains live data.

6. The method of displaying video data of claim 0, wherein said first video data stream comprises pre-processed data stored in a memory device.

7. A method of transitioning between displaying on a display device a first video signal to displaying a second video signal, wherein the first and second video signals comprise frames of data separated by vertical blanking pulses and wherein the first and second video signals are asynchronous, the method comprising:
receiving the first video signal and outputting the first video signal for display on the display device;
receiving a command to switch from the displaying the first video signal to the second video signal;
upon receipt of a next vertical blanking pulse of the first video signal, prolonging said next vertical blanking pulse until a new frame of the second video signal starts; and
de-asserting said next vertical blanking pulse and outputting the second video signal for display on the display device.

8. The method of displaying video signals of claim 7, wherein the first video signal comprises pre-processed video data stored in a memory and the second video signal comprises a real-time video stream.

9. A video display apparatus including a video display device, and a display controller for supplying to said display device a combined video data signal comprising first and second video data streams and a transition between said first and second video data streams, said first and second video data streams comprising respectively frames separated by vertical blanking pulses, and said first and second video data streams being asynchronous, wherein said display controller is operative during said transition to include in said combined video signal:
video data from said first video data stream that is updated until assertion of a vertical blanking pulse terminates a frame in said first video stream;
a prolonged vertical blanking pulse asserted in response to assertion of said vertical blanking pulse in said first video stream, and de-asserted in response to de-assertion of a subsequent vertical blanking pulse in said second video stream; and
video data from said second video data stream starting with a frame following de-assertion of said prolonged vertical blanking pulse.

10. The video display apparatus of claim 0, wherein said display controller receives a switching signal that triggers said transition from said first video data stream to said second video data stream.

11. The video display apparatus of claim 0, wherein said display controller interrupts updating said display on said video display device in response to a first occurrence of assertion of said vertical blanking pulse in said first video stream following said switching signal.

12. The video display apparatus of claim 0, wherein said display controller is responsive to a first occurrence of de-assertion of said vertical blanking pulse in said second video stream following said assertion of said vertical blanking pulse in said first video stream to include in said combined video data signal video data from said second video data stream, wherein the duration of said prolonged vertical blanking interval is less than a duration of one frame of said first or second video data stream.

13. The video display apparatus of claim 0, wherein one of said first and second video data streams includes a live data source.

14. The video display apparatus of claim 0, wherein the display controller includes a pre-processor and memory data source for supplying pre-processed data stored in the memory data source for said first video data stream.

15. A video display apparatus, comprising:
a memory for storing video data for a first video signal, the first video signal including frames of data separated by vertical blanking pulses;
a multiplexer having a first input connected to the memory for receiving the first video signal, a second input for receiving a second video signal, and a control input that receives a switch control signal for selecting between outputting the first and second video signals;
a display driver connected to the multiplexer for receiving and outputting the selected one of the first and second video signals; and
a timing generator for prolonging a vertical blanking pulse of the first video signal, wherein upon receipt of the switch control signal, the timing generator prolongs the next vertical blanking pulse of the first video signal and upon receipt of a new frame of the second video signal, de-assets the prolonged vertical blanking pulse.

16. The video display apparatus of claim 0, further comprising a display device connected to the display driver for receiving and displaying the selected one of the first and second video signals.

17. The video display apparatus of claim 0, further comprising a pixel manipulator connected between the display device and the display driver.

18. The video display apparatus of claim 0, a data requestor for fetching the first video signal from the memory.

19. The video display apparatus of claim 0, wherein the first video signal comprises pre-processed image data and the second video signal comprises a real-time video signal.
